(19) United States
(12) Patent Application Publication
(10) Pub. No.: US 2026/0356173 A1
(43) Pub. Date: Nov. 12, 2026

(54) METHOD FOR PATHOGEN CONTROL IN A VEHICLE HEAT PUMP SYSTEM

(71) Applicant: JAGUAR LAND ROVER LIMITED, Warwickshire (GB)

(72) Inventors: George Barnwell, Whitley, Coventry, Warwickshire (GB); Mark Allen, Whitley, Coventry, Warwickshire (GB); Chris Chatham, Whitley, Coventry, Warwickshire (GB)

(21) Appl. No.: 19/102,040

(22) PCT Filed: Aug. 3, 2023
(86) PCT No.: PCT/EP2023/071501

§ 371 Date: Feb. 7, 2025

(30) Foreign Application Priority Data
Aug. 8, 2022 (GB) 2211549.7

(51) Int. Cl. B60H 3/00; B60H 1/00; B60H 1/32

(52) U.S. Cl. CPC B60H 3/0092; B60H 1/00764; B60H 1/00785; B60H 1/3205; B60H 2001/3245; B60H 2001/3261

(57) ABSTRACT

The present invention relate to a control system (100) for controlling a vehicle heat pump system (200, 300), the vehicle heat pump system (200, 300) operable in a heating mode at a first pressure, wherein the control system (100) comprises one or more controllers (110) and is configured to: receive a moisture signal indicative of moisture on a surface of a first thermal exchanger (210, 310) of the vehicle heat pump system (200, 300); determine a requirement to remove moisture in dependence on the moisture signal; and output a control signal (155) to control the vehicle heat pump system (200, 300) to operate at a second pressure greater than the first pressure such that the surface of the first thermal exchanger (210, 310) is heated to remove moisture from the surface.

### TECHNICAL FIELD

The present disclosure relates to a method for pathogen control in a vehicle heat pump system. Aspects of the invention relate to a control system, a vehicle heat pump system, a vehicle, a method, and computer readable instructions.

### BACKGROUND

It is known to provide temperature control to a vehicle cabin by using a heat pump operable in a heating mode and a cooling mode. In the heating mode, a thermal exchange unit of the heat pump is heated and air is blown over the heated thermal exchange unit into the vehicle cabin to warm the air and thus the vehicle cabin. In the cooling mode, the same thermal exchange unit is cooled, and may cool air blown over the thermal exchange unit. The heat pump system may provide heating or cooling air conditioning functions to a vehicle.

A common problem associated with vehicle air conditioning systems is an accumulation of moisture on a surface of the thermal exchange unit. This is particularly prevalent after the thermal exchange unit is cooled to provide an air conditioning function, due to the cooler surface temperature of the thermal exchange unit compared to its surroundings. The moisture on the surface of the thermal exchange unit may provide an environment conducive to bacterial growth. Over time, use of the air conditioning unit may introduce unpleasant smells associated with the bacterial growth into the vehicle cabin as well as pathogens. As such, maintenance of the heat pump system may be required to maintain a clean surface of the thermal exchange unit to prevent occurrence of smells and to maintain air quality when using the air conditioning system. In particular, reducing presence of pathogens is important to the maintenance of the vehicle.

It is known to attempt to dry the surface of the thermal exchange unit without removing the thermal exchange unit from the vehicle or requiring manual access to the location of the thermal exchange unit, which in a conventional vehicle, may be provided under a bonnet. For example, a dedicated heating element such as a conductive filament heater may be provided proximal to the surface of the thermal exchange unit to heat and thereby dry the surface. Another approach may involve directing air flow to carry heat from a heat source such as a vehicle engine such that heated air blows over the surface of the thermal exchange unit. However, such approaches have drawbacks, including increased component count and manufacturing or installation difficulties due to requiring additional dedicated components such as heating elements, fans, blowers or elements to direct airflow, and may interfere with the normal operation of the vehicle temperature control systems by blocking desired air flow directions or interfering with thermal exchange between the thermal exchange units and the surrounding air.

It is an aim of the present invention to address one or more of the disadvantages associated with the prior art.

### SUMMARY OF THE INVENTION

Aspects and embodiments of the invention provide a control system, a vehicle heat pump system, a vehicle, a method, and computer readable instructions as claimed in the appended claims.

According to an aspect of the present invention there is provided a control system for controlling a vehicle heat pump system, the vehicle heat pump system operable in a heating mode at a first pressure, wherein the control system comprises one or more controllers and is configured to:
receive a moisture signal indicative of moisture on a surface of a first thermal exchanger of the vehicle heat pump system;
determine a requirement to remove moisture in dependence on the moisture signal; and
output a control signal to control the vehicle heat pump system to operate at a second pressure greater than the first pressure such that the surface of the first thermal exchanger is heated to remove moisture from the surface.

Advantageously, the control system may control the vehicle heat pump system to operate in the heating mode at a pressure greater than normal operating pressures to remove moisture from the surface of the first thermal exchanger. Advantageously, removing moisture from the surface of the first thermal exchanger may inhibit growth of bacteria or pathogens and maintain a clean vehicle environment. By utilising a heating mode of the vehicle heat pump system but operating at the second pressure greater than the first pressure, moisture may be removed without requiring dedicated components such as heating elements for removing the moisture. Consequently, the vehicle heat pump system may be simplified by not requiring dedicated components for drying the surface of the first thermal exchanger.

In some examples, the control signal controls the vehicle heat pump system to operate in the heating mode at the second pressure so as to heat the surface of the first thermal exchanger. Advantageously, an existing mode of the vehicle heat pump system may be used to heat the surface of the first thermal exchanger. Heating the surface of the first thermal exchanger may deactivate or destroy bacteria or pathogens present on the surface.

In some examples, the moisture signal is indicative of at least one of: the temperature or humidity proximal to the first heat exchanger; a use history of the vehicle heat pump system indicating that the vehicle heat pump system has previously operated in a cooling mode; a user input for removing moisture from the surface of the first thermal exchanger; and an identification that a vehicle comprising the vehicle heat pump system has completed a journey. Advantageously, the control system may control the vehicle heat pump system to operate in the heating mode at the second pressure to remove moisture from the surface of the first thermal exchanger at a time when it is likely that moisture is present. In some cases, moisture may accumulate on the surface after the first thermal exchanger becomes cool during a cooling operation. Advantageously, the efficiency of the vehicle heat pump system is maintained by being operated to remove moisture only when it is likely that moisture is present.

In some examples, the control system is configured to control the vehicle heat pump system to operate in the heating mode at the second pressure for a pre-determined time period to dry the surface of the first thermal exchanger. Advantageously, the vehicle heat pump system may be operated in the heating mode at the second pressure for a pre-determined time until the surface is dry, and then may be switched off to improve system efficiency.

In some examples, the control system is configured to control the vehicle heat pump system to operate in the heating mode until a pre-determined humidity or temperature threshold is reached in dependence on humidity information or temperature information received from at least one sensor. Advantageously, the vehicle heat pump system is not operated unnecessarily, and efficiency is improved.

In some examples the control system is configured to, in dependence on determining the requirement to remove moisture, send an output indication to the user requesting a user confirmation, and in dependence on receiving the user confirmation, output the control signal to control the vehicle heat pump system to operate at the second pressure. Advantageously, requesting a user confirmation on the basis of the moisture signal may allow a user to defer operation to a more convenient time, for example after the last journey of the day.

Furthermore, in the case where the moisture signal is indicative of a user input, the output to the user may act as an additional confirmation step.

In some examples the control system is configured to receive a signal indicative that the vehicle has completed a journey, and the control system is configured to defer output of the control signal to control the vehicle heat pump system to operate at the second pressure until receipt of the signal indicative that the vehicle has completed the journey. In this way, the system may wait to control the vehicle heat pump system to operate at the second pressure until the vehicle is no longer in use, which may avoid any driver discomfort. In examples where the control system is configured to send an output indication to the user, the control system may defer the output indication to a user requesting a user confirmation until the receipt of the signal indicative that the vehicle has completed a journey.

In some examples, the second pressure is between 14 bar and 20 bar. Advantageously, a temperature of the surface of the first thermal exchanger may be raised to at least 50 °C or 60 °C

In some examples, the first pressure is up to 14 bar.

In some examples, the control system is configured to control the vehicle heat pump system to operate at the second pressure in the heating mode such that a temperature of the surface of the first thermal exchanger is raised to at least 50 °C. Advantageously, the surface of the first thermal exchanger may be effectively dried at 50 °C

In some examples, the control system is configured to control the vehicle heat pump system to operate at the second pressure in the heating mode such that a temperature of the surface of the first thermal exchanger is raised to at least 60 °C. In some examples, the temperature is 69 °C. Advantageously, bacteria or pathogens present on the surface may be destroyed.

Advantageously, a temperature of sufficient to remove moisture from the surface of the first thermal exchanger may be achieved when the second pressure is 14 bar, and a temperature sufficient to destroy or deactivate bacteria or pathogens directly may be achieved when the second pressure is approximately 20 bar.

According to another aspect of the present invention there is provided a vehicle heat pump system operable in a heating mode at a first pressure, the vehicle heat pump system comprising: a first thermal exchanger; and the control system.

In some examples, the vehicle heat pump system comprises a compressor configured to compress a fluid and thereby heat the fluid.

In some examples, the vehicle heat pump system comprises a control valve configured to control a direction of flow of the fluid around the vehicle heat pump system to thereby operate the vehicle heat pump system in the heating mode or a cooling mode. Advantageously, the vehicle heat pump system may be operable in the heating mode and the cooling mode to provide efficient heating and cooling to the vehicle.

In some examples, the vehicle heat pump system comprises a thermal expansion valve connected between the compressor and the first thermal exchanger, and configured to control a flow rate of the compressed fluid to control expansion of the compressed fluid to thereby cool the fluid in the cooling mode.

In some examples, the vehicle heat pump system comprises a second thermal exchanger connected between the compressor and the thermal expansion valve.

In some examples, in the heating mode the first thermal exchanger is operable as a condenser, and in the cooling mode the first thermal exchanger is operable as an evaporator.

In some examples, in the heating mode the second thermal exchanger is operable as an evaporator, and in the cooling mode the second thermal exchanger is operable as a condenser.

In some examples, the vehicle heat pump system comprises an accumulator connected between the first thermal exchanger and the compressor.

In some examples, the fluid is a refrigerant.

In some examples, the thermal expansion valve is configured to cool the fluid via the throttling phenomenon.

In some examples, the control system is configured to output the control signal to control the vehicle heat pump system to operate at the second pressure in the heating mode such that a temperature of the surface of the first thermal exchanger is raised to at least 50 °C Advantageously, the surface of the first thermal exchanger may be effectively dried at 50 °C

In some examples, the control system is configured to output the control signal to control the vehicle heat pump system to operate at the second pressure in the heating mode such that a temperature of the surface of the first thermal exchanger is raised to at least 60 °C. In some examples, the temperature is 69 °C. Advantageously, bacteria or pathogens present on the surface may be destroyed.

In some examples, the vehicle heat pump system comprises a control valve configured to control a direction of flow of the fluid around the vehicle heat pump system to thereby operate the vehicle heat pump system in the heating mode or a cooling mode. The control valve comprises a three-way valve configured to selectively connect a compressor and the first thermal exchanger via a thermal expansion valve, and to selectively connect the compressor and a second thermal exchanger. The three-way valve is configured to selectively direct the fluid to bypass the second thermal exchanger such that hot fluid is circulated through the compressor, the three-way valve, the thermal expansion valve and the first thermal exchanger. Advantageously, the vehicle heat pump system may be operated in the heating mode or the cooling mode by controlling the direction of flow of the fluid around the vehicle heat pump system to heat or cool the first thermal exchanger.

In some examples, the vehicle heat pump system comprises a valve operable between being opened or restricted to selectively contain fluid in the first thermal exchanger; and the control system is configured to, in response to receiving the moisture signal, output a control signal to control the valve to be restricted to thereby contain hot fluid in the first thermal exchanger. Advantageously, hot refrigerant may be circulated through the first thermal exchanger without being cooled by passing through the second thermal exchanger. Thus an efficiency of operating the vehicle heat pump system in the heating mode at the second pressure may be improved.

In some examples, the valve comprises a second thermal expansion valve.

In some examples, the vehicle heat pump system comprises at least one of a temperature sensor configured to detect a temperature proximal to the first thermal exchanger or a humidity sensor configured to detect humidity proximal to the first thermal exchanger; and the moisture signal includes at least one of the detected temperature or the detected humidity. Advantageously, the vehicle heat pump system may determine when moisture is present on the surface of the first thermal exchanger and so operate in the heating mode at the second pressure when needed. Further, the vehicle heat pump system may determine when moisture has been successfully removed or a target temperature of the surface of the first thermal exchanger has been achieved, and so cease operation.

In some examples, the vehicle heat pump system comprises a blower configured to blow air across the surface of the first thermal exchanger; and the control system is configured to control the fan to operate at a low speed to blow air across the surface of the first thermal exchanger when it is determined to dry the surface of the first thermal exchanger. Advantageously, moisture in the air surrounding the first thermal exchanger may be dissipated and the removal of moisture from the surface may be accelerated, while power consumption of the blower is reduced.

According to another aspect of the present invention there is provided a vehicle comprising the control system or the vehicle heat pump system.

According to another aspect of the present invention there is provided a method for removing moisture from a surface of a first thermal exchanger of a vehicle heat pump system operable in a heating mode at a first pressure, the method comprising:
receiving a moisture signal indicative of moisture on a surface of the first thermal exchanger;
determining a requirement to remove moisture in dependence on the moisture signal; and
outputting a control signal to control the vehicle heat pump system to operate at a second pressure greater than the first pressure such that the surface of the first thermal exchanger is heated to remove moisture from the surface.

In some examples, the second pressure is between 14 bar and 20 bar.

In some examples, the moisture signal is indicative of at least one of: a use history of the vehicle heat pump system indicating that the vehicle heat pump system has previously operated in a cooling mode; a user input for removing moisture from the surface of the first thermal exchanger; and an identification that a vehicle comprising the vehicle heat pump system has completed a journey. Advantageously, the control system may control the vehicle heat pump system to operate in the heating mode at the second pressure to remove moisture from the surface of the first thermal exchanger at a time when it is likely that moisture is present. In some cases, moisture may accumulate on the surface after the first thermal exchanger becomes cool during a cooling operation. Advantageously, the efficiency of the vehicle heat pump system is maintained by being operated to remove moisture only when it is likely that moisture is present.

In some examples, the method comprises detecting a temperature proximal to the first thermal exchanger or a humidity proximal to the first thermal exchanger; and the moisture signal includes at least one of the detected temperature or the detected humidity. Advantageously, the vehicle heat pump system may determine when moisture is present on the surface of the first thermal exchanger and so operate in the heating mode at the second pressure when needed. Further, the vehicle heat pump system may determine when moisture has been successfully removed or a target temperature of the surface of the first thermal exchanger has been achieved, and so cease operation.

In some examples, the method comprises controlling the vehicle heat pump system to operate in the heating mode for a pre-determined time period to dry the surface of the first thermal exchanger.

In some examples, the method comprises controlling the vehicle heat pump system to operate in the heating mode until a pre-determined humidity or temperature threshold is reached.

In some examples, the method comprises: controlling the vehicle heat pump system to operate at the second pressure in the heating mode, such that a temperature of the surface of the first thermal exchanger is raised to at least 50 °C; or controlling the vehicle heat pump system to operate at the second pressure in the heating mode, such that a temperature of the surface of the first thermal exchanger is raised to at least 60 °C. Advantageously, moisture may be effectively removed from the surface when the surface is heated to 50 °C Advantageously, bacteria or pathogens present on the surface of the first thermal exchanger may be destroyed or deactivated when the surface is heated to at least 60 °C

According to another aspect of the present invention, there is provided computer readable instructions which, when executed by a computer, are arranged to perform the method.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a block diagram representation of a control system according to an embodiment of the invention;

FIG. 2 shows a block diagram representation of a vehicle heat pump system according to an embodiment of the invention;

FIG. 3 shows a block diagram representation of a vehicle heat pump system according to an embodiment of the invention;

FIG. 4 shows a flowchart illustrating a method for drying a surface of a thermal exchanger of a vehicle heat pump system according to an embodiment of the invention; and

FIG. 5 shows a vehicle in accordance with an embodiment of the invention.

### DETAILED DESCRIPTION

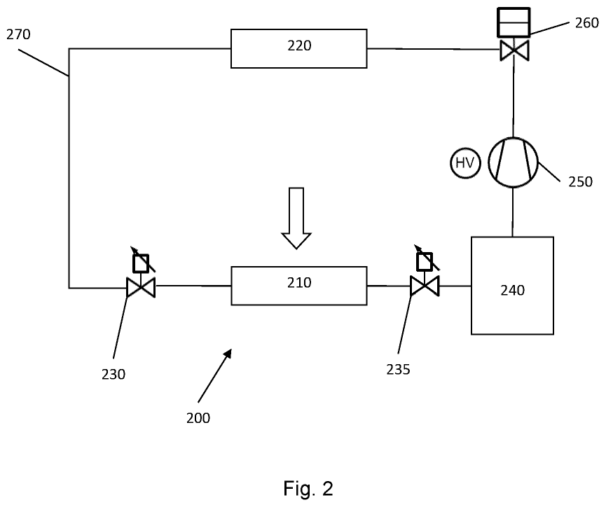

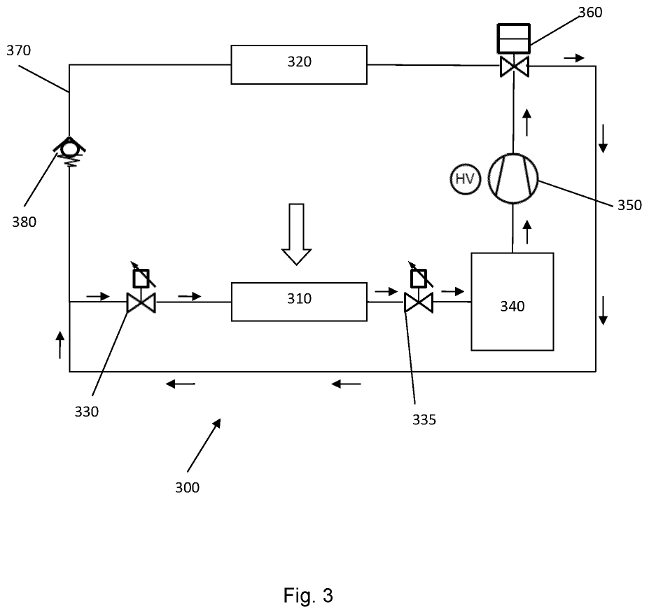

The present disclosure relates to a vehicle heat pump system and methods of operating said vehicle heat pump system to dry a surface of a thermal exchanger. As will be explained in more detail with respect to FIGS. 2 and 3, the heat pump typically includes a compressor, two thermal exchange units operable as a condenser and an evaporator, and at least one expansion device. Fluid, such as a refrigerant, is compressed by the compressor, then passed through one of the thermal exchange units, the expansion device, the second thermal exchange unit and back to the compressor. The temperature of the fluid is varied during this process due to the throttling effect which occurs in the expansion device and the compression of the fluid which occurs in the compressor. The flow direction of the fluid may be reversable or a route of the flow of the fluid may be changed to switch between the heating mode and the cooling mode, such that a thermal exchange unit proximal to air flow into the vehicle cabin is either heated or cooled by the fluid passed therethrough, to thereby heat or cool the vehicle cabin.

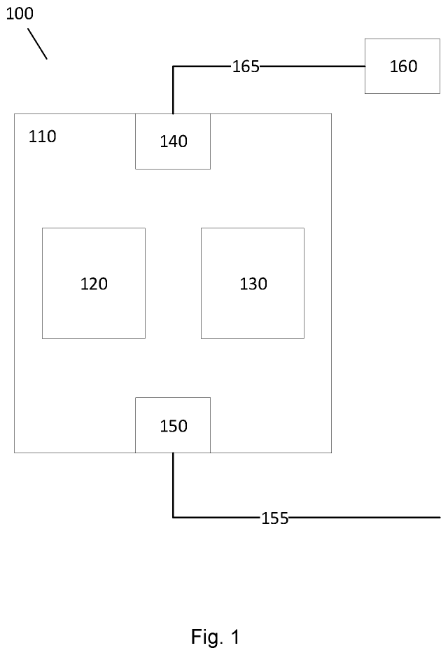

A control system 100 in accordance with an embodiment of the present invention is described herein with reference to the accompanying FIG. 1. FIG. 1 shows a block diagram representation of a control system 100 according to an embodiment of the invention.

With reference to FIG. 1, the control system 100 comprises one or more controller 110. In use, the control system 100 may be communicatively coupled to a vehicle heat pump system operable in a heating mode at a first pressure, and the control system 100 may be configured to control an operation of the vehicle heat pump system.

The control system 100 is configured to receive a moisture signal indicative of moisture on a surface of a first thermal exchanger of the vehicle heat pump system. The thermal exchanger may also be referred to as a thermal exchange unit. The control system 100 may determine a requirement to remove moisture from the surface of the first thermal exchanger in dependence on the moisture signal. The control system 100 may then output a control signal 155 to control the vehicle heat pump system to operate in the heating mode at a second pressure. The second pressure may be higher than the first pressure. In some examples, the second pressure may be between 14 bar and 20 bar. The first pressure, being a maximum operating pressure during normal operation of the vehicle heat pump system to heat or cool a vehicle cabin, may be approximately 14 bar, but it should be understood that the vehicle heat pump system may operate at other pressures as well in dependence on required heating or cooling. It should be understood that the maximum pressure the system is able to achieve may be limited by physical constraints of system components, as will be discussed in respect of FIG. 2. However, the control system 100 may control the vehicle heat pump system to operate in the heating mode at a second pressure greater than a normal operating pressure of the system in the normal heating mode for heating the vehicle cabin. The control system 100 may further receive information 165 indicative of a detected temperature or humidity proximal to the first thermal exchanger from one or more sensor 160, and may determine the requirement to remove moisture in dependence on the received information 165. In some examples, the temperature or humidity information may be included in the moisture signal.

Operating the vehicle heat pump system in the heating mode at the second pressure may raise a temperature of the surface of the first thermal exchanger to a higher temperature than usual operating temperatures sufficient to remove moisture from the surface of the first thermal exchanger. The temperature of the surface of the first thermal exchanger is related to the pressure of the vehicle heat pump system in the heating mode. For example, if the vehicle heat pump system is operated in heating mode at 14 bar, the temperature of the surface of the first thermal exchanger may be raised to approximately 50 °C. If the vehicle heat pump system is operated in heating mode at 20 bar, the temperature of the surface of the first thermal exchanger may be raised to approximately 60 °C or 69 °C in some examples. The vehicle heat pump system may operate at the first pressure during normal use of the vehicle heat pump system to heat the vehicle cabin. The first pressure may be up to 14 bar in some examples. Advantageously, by heating the surface of the first thermal exchanger to approximately 50 °C, moisture may be removed from the surface of the first thermal exchanger by evaporation. It would be understood that removal of moisture from the surface of the thermal exchanger inhibits bacterial growth on the surface of the thermal exchanger, and may also reduce pathogen loading. Advantageously, by heating the surface of the first thermal exchanger to approximately 60 °C or 69 °C, moisture may be removed from the surface of the first thermal exchanger by evaporation, and bacteria or pathogens present on the surface of the first thermal exchanger or in air proximal to the first thermal exchanger should be deactivated or destroyed. The pressure of the vehicle heat pump system may be controlled by at least one of a compressor and an expansion device.

The control system 100 as illustrated in FIG. 1 comprises one controller 110, although it will be appreciated that this is merely illustrative. The controller 110 comprises processing means 120 and memory means 130. The processing means 120 may be one or more electronic processing device 120 which operably executes computer-readable instructions. The memory means 130 may be one or more memory device 130. The memory means 130 is electrically coupled to the processing means 120. The memory means 130 is configured to store instructions, and the processing means 120 is configured to access the memory means 130 and execute the instructions stored thereon.

The controller 110 comprises an input means 140 and an output means 150. The input means 140 may comprise an electrical input 140 of the controller 110. The output means 150 may comprise an electrical output of the controller 110. The input 140 is arranged to receive a moisture signal. The input 140 may also be arranged to receive at least one of a temperature signal 165 or a humidity signal 165 from a temperature sensor 160 or a humidity sensor 160. The moisture signal, the temperature signal 165 and the humidity signal 165 may be electrical signals respectively indicative of moisture present on a surface of the first thermal exchanger, a temperature detected by the temperature sensor 160, and a humidity detected by the humidity sensor 160. Although the sensor 160 is shown as being outside of the controller 110, the controller 110 may comprise the sensor 160 as an integrated module. The output 150 is arranged to output a control signal 155 for controlling the vehicle heat pump system to operate in the heating mode at the second pressure. The control signal 155 may be output by the output 150 to the vehicle heat pump system.

The controller 110 may also be communicatively coupled with one or more further sensors (not shown in FIG. 1) or vehicle communication networks to determine information about the vehicle heat pump system. The controller 110 may also be communicatively coupled with a vehicle control system such as a system including a vehicle communication bus, which may relay information and control signals between various components and systems of a vehicle. For example, the controller 110 may receive the moisture signal through the vehicle control system. The controller 110 may also receive control signals corresponding to user inputs on a user interface module in the vehicle.

The moisture signal may be indicative of moisture on the surface of a first thermal exchanger of the vehicle heat pump system. In some examples, the moisture signal is indicative of a use history of the vehicle heat pump system indicating that the vehicle heat pump system has previously operated in a cooling mode. That is, the vehicle heat pump system may operate in a cooling mode to cool a vehicle cabin and provide an air conditioning function to the vehicle cabin. During the cooling mode, the first thermal exchanger is cooled by cold fluid passing through the first thermal exchanger. Due to the first thermal exchanger being cooler than surrounding air, moisture may accumulate on the surface of the first thermal exchanger. Therefore, the control system 100 may determine to operate the vehicle heat pump system in the heating mode at the second pressure to remove moisture from the surface of the first thermal exchanger and/or to destroy bacteria and pathogens on the surface of the first thermal exchanger if it is determined that the vehicle heat pump system has been operated in the cooling mode. Removing moisture from the surface of the thermal exchanger reduces the growth of bacteria on the surface of the thermal exchanger, which benefits from a damp environment. For example, it may be determined to initiate the drying process when it is determined that the vehicle heat pump system has been operated in the cooling mode for a predetermined time. The control system 100 may determine to operate the vehicle heat pump system in the heating mode at the second pressure when it is determined that a vehicle has completed a journey, so as not to interfere with a user's desired heating or cooling functions.

In another example, the moisture signal may be received in dependence on a user's request to dry the surface of the first thermal exchanger. The moisture signal may comprise the user's request to dry the surface of the first thermal exchanger. In some examples, the moisture signal may be any of the non-user requested indication signals, and in response to receiving that indication signal, the control system 100 may output an indication to the user recommending that the vehicle heat pump system, or the vehicle HVAC system, is sanitised to reduce a presence of bacteria or pathogens. To this end, the control system 100 may output an indication recommending a process corresponding to a process for removing moisture from the vehicle heat pump system. The user may confirm that the process should be initiated. The control system, in dependence on the user confirmation, then outputs the control signal to the vehicle heat pump system. In some examples, the recommendation may be provided to the user based on a time since a previous execution of the drying process exceeding a predetermined threshold, or based on a use of the vehicle heat pump system in the cooling mode. The user may also decide to initiate the drying process without a recommendation to do so being output. Alternatively or in addition, the control system 100 may determine to remove moisture from the surface of the first thermal exchanger in dependence on temperature or humidity information 165 received from the at least one sensor 160. For example, the at least one sensor 160 may be provided proximal to the first thermal exchanger and may measure at least one of a temperature or a humidity proximal to the first thermal exchanger. If the measured temperature or humidity exceed a predetermined threshold, a requirement to remove moisture from the first thermal exchanger may be determined.

In some examples, the control system may determine a requirement to remove moisture from the first thermal exchanger at a point where the vehicle is still in use. While the vehicle is in use, the user may wish to maintain the temperature of the vehicle heat pump until a journey is completed. The control signal may therefore be configured to receive a signal that the journey is completed, and upon receipt of that signal then output the control signal. Put another way, the control system may be configured to defer output of the control signal to control the vehicle heat pump system to operate at the second pressure until receipt of the signal indicative that the vehicle has completed the journey.

In some examples, when a requirement to remove moisture from the surface of the first thermal exchanger is determined, the vehicle heat pump system may be operated in the heating mode at the second pressure for a predetermined time. In another example, the vehicle heat pump system may be operated in the heating mode at the second pressure until a temperature or humidity value measured by the at least one sensor 160 reaches a predetermined value.

FIG. 2 illustrates a vehicle heat pump system 200 according to an embodiment of the present invention. The vehicle heat pump system 200 may comprise a control system 100 as illustrated in FIG. 1, although this is not shown in FIG. 2. For example, the vehicle heat pump system 200 may operate under the control of the control system 100 of FIG. 1.

The vehicle heat pump system 200 comprises a first thermal exchanger 210, a second thermal exchanger 220, an expansion device 230, an accumulator 240, a compressor 250, and a control valve 260. However, it should be understood that not all of these components are essential, and one or more components may be omitted. For example, at least the accumulator 240 may be omitted. Fluid, such as a refrigerant or a coolant, may be conducted around the vehicle heat pump system 200 via conduits 270. Air from sources internal and external to a vehicle comprising the vehicle heat pump system 200 may be drawn past the vehicle heat pump system 200 to heat or cool the air.

The first thermal exchanger 210 and the second thermal exchanger 220 may comprise thermal exchange units configured to exchange thermal energy with surrounding air. The thermal exchangers 210 220 may also be known as thermal exchange units, heat exchangers or heat exchange units. It should be understood that any suitable type of thermal exchanger may be used, including shell and tube heat exchangers, plate heat exchangers, plate and shell heat exchangers, plate fin heat exchangers, finned tube heat exchangers, pillow plate heat exchangers, microchannel heat exchangers and coil heat exchangers. The selection of the type of thermal exchanger to be used may be determined based on maximum operating temperatures or pressures of the thermal exchangers. The first thermal exchanger 210 and the second thermal exchanger 220 are configured to control passage of fluid through the first thermal exchanger 210 and the second thermal exchanger 220 and to facilitate an exchange of thermal energy between the fluid within the first thermal exchanger 210 and the second thermal exchanger 220 and surrounding air.

The compressor 250 is configured to compress fluid. The compressor 250 may comprise any suitable type of compressor. The compressor 250 may be configured to compress the fluid to up to a first pressure during normal operation of the vehicle heat pump system 200 in a heating mode or a cooling mode. The first pressure may be up to 14 bar in some examples. However, the compressor 250 may be configured to compress the fluid to a lower pressure than the first pressure during operation, or it may be considered that the first pressure may be varied depending on temperature requirements of the vehicle heat pump system 200 based on a user or vehicle control of desired vehicle cabin temperature. The pressure referred to herein is a pressure of the fluid in the first thermal exchanger 210. It should be understood, as will be discussed below, that the pressure of the fluid will vary between different locations in the vehicle heat pump system 200 due to the operation of the vehicle heat pump system 200 to implement heating and cooling functions. The pressure of the vehicle heat pump system 200 may be determined by a required temperature for the removal of moisture from the surface of the first thermal exchanger 210. That is, if it is desired to remove moisture from the surface of the first thermal exchanger 210, the target temperature to be achieved at the surface of the first thermal exchanger 210 may be 50 °C and the pressure may be approximately 14 bar, but if it is desired to destroy pathogens on the surface of the first thermal exchanger 210 directly, the desired temperature may be 69 °C and the pressure may be approximately 20 bar.

The control valve 260 comprises a valve configured to control a direction of flow of the fluid around the vehicle heat pump system 200. The control valve 260 may comprise a three-way valve, a T-valve or a reversing valve in some examples. The control valve 260 is configured to control a direction of flow of the fluid around the vehicle heat pump system 200 under the control of a controller such as the control system 100 of FIG. 1. The direction of flow of the fluid around the vehicle heat pump system 200 determines whether the vehicle heat pump system 200 operates in the heating mode or the cooling mode. That is, when the fluid is directed in a first direction around the vehicle heat pump system 200, the first thermal exchanger 210 becomes heating due to hot fluid being passed through the first thermal exchanger 210, and thus air blown across the first thermal exchanger by a fan (indicated by the arrow of FIG. 2) may be heated and provided to a vehicle cabin to warm the vehicle cabin. The control valve 260 may change a direction of flow of the fluid to a second direction of flow, in which cold fluid is passed through the first thermal exchanger 210 and air blown over the first thermal exchanger 210 is cooled and provided to the vehicle cabin to cool the vehicle cabin. It should be understood that the conduits 270 and the control valve 260 of FIG. 2 may show a simplified configuration of fluid pathways, and that the control valve 260 may change the direction of flow of fluid around the vehicle heat pump system 200 by directing the fluid to other (not shown) conduits. However, it should be understood that the present disclosure is not limited to the exact construction of the vehicle heat pump system 200 shown in FIG. 2, and any heat pump system operable in a heating mode and a cooling mode may be used to implement the present invention.

The accumulator 240 comprises a vessel or a container to contain fluid awaiting compression in the compressor 250.

The expansion device 230 is configured to control a rate of flow of fluid through the expansion device 230 and to produce a cooling effect on the fluid via the throttling effect. The expansion device 230 may alternatively be known as a thermal expansion valve or a metering device. For example, the expansion device 230 may comprise a capillary tube or pressure-controlled valve. The expansion device 230 may restrict a flow of fluid through the expansion device 230 to reduce a pressure of the fluid and to allow isenthalpic expansion of the fluid from a liquid phase to a vapor phase at a lower temperature. The temperature of the fluid is thereby reduced as it passes through the expansion device 230.

One or more conduits 270 are provided to connect between the first thermal exchanger 210, the second thermal exchanger 220, the expansion device 230, the accumulator 240, the compressor 250 and the control valve 260. The conduits 270 may comprise a continuous channel or multiple channel sections, and may be configured to contain the fluid and control the flow of fluid between the components of the vehicle heat pump system 200.

A basic operation of the vehicle heat pump system 200 in the cooling mode is as follows. In the cooling mode, fluid may flow anti-clockwise around the vehicle heat pump system 200 of FIG. 2. First, fluid is compressed in the compressor 250 to a high pressure, high temperature gaseous state. The fluid passes through the control valve 260 to the second thermal exchanger 220, which in the cooling mode acts as condenser. The fluid exchanges thermal energy with surrounding air and is partially cooled and condensed to a high pressure fluid in a liquid state. The high pressure liquid fluid passes through the expansion device 230 and at least a part of the fluid undergoes isenthalpic expansion back to a gaseous state. Due to the flow restriction of the expansion device 230 and consequent pressure difference discussed above, the temperature of the fluid is reduced as it passes through the expansion device 230. The fluid may undergo adiabatic flash evaporation at this stage. The cold fluid (which may comprise a liquid and vapor mix) then passes through the first thermal exchanger 210, and exchanges thermal energy with the surrounding air. A fan may blow air across the surface of the first thermal exchanger 210 to provide cool air to a vehicle cabin as indicated in FIG. 2 by the arrow. The first thermal exchanger 210 acts as an evaporator in the cooling mode, and fluid passing through the first thermal exchanger evaporates to a gaseous state. The fluid then returns to the compressor 250 via the accumulator 240 and the cycle begins again.

During the cooling mode, moisture may accumulate on the surface of the first thermal exchanger 210 due to a temperature of the surface being lower than a temperature of surrounding air. The moisture may accumulate and lead to bacteria growth due to the damp environment and an associated smell and pathogen increase may be undesirable. Therefore, the control system 100 or the vehicle heat pump system 200 may receive a moisture signal indicative of moisture on the surface of the first thermal exchanger 210 and may determine a requirement to remove the moisture. Upon determining to remove the moisture, the vehicle heat pump system 200 may operate in the heating mode at a second pressure to thereby heat the surface of the first thermal exchanger 210 to remove moisture. As discussed above, the second pressure may be greater than the first pressure, which is the normal operating pressure of the vehicle heat pump system 200, and thus a high temperature of the surface of the first thermal exchanger 210 may be reached. The second pressure may be between 14 bar and 20 bar in some examples, which may correspond to a surface temperature of the first thermal exchanger 210 of between 50 °C and 69 °C. As explained above with respect to FIG. 1, the moisture signal or the determination of the requirement to remove moisture may be based on a number of factors, including a use history of the vehicle heat pump system 200 in the cooling mode, an identification of an end of a journey of the vehicle, a user request, a regular maintenance cycle, or temperature or humidity information.

The vehicle heat pump system 200 of FIG. 2 may comprise a second expansion device 235. The second expansion device 235 may be similar or the same as the first expansion device 230, and may be provided so that the vehicle heat pump system 200 of FIG. 2 is operable in either direction to operate the vehicle heat pump system 200 in a heating mode or a cooling mode. That is, when the vehicle heat pump system 200 is operated in the heating mode, the second expansion device 235 may perform similar operations to those of the first expansion device 230 in the cooling mode explained above.

To operate the vehicle heat pump system 200 in the heating mode, the flow direction of the fluid around the vehicle heat pump system 200 is reversed by the control valve 260. As explained above, it should be understood that FIG. 2 may show a simplified configuration of the control valve 260 and the conduits 270 to aid in understanding, and that any alternative configuration of a heat pump system operable in a cooling mode and a heating mode may be used. In the example of FIG. 2, the fluid may pass clockwise around the vehicle heat pump system 200 in the heating mode: from the compressor 250 to the second expansion device 235, to the first thermal exchanger 210 to heat the first thermal exchanger 210, through the expansion device 230 to the second thermal exchanger 220, through the control valve 260 and back to the compressor 250. It should be understood that in this case the roles of the first thermal exchanger 210 and the second thermal exchanger 220 are reversed in comparison to the operation of the vehicle heat pump system 200 in the cooling mode. In this case, the second expansion device 235 may perform a similar operation to that of the first expansion device 230 in the cooling mode, and ensures condensing of the fluid upstream of the accumulator 240.

The vehicle heat pump system 200 or the control system 100 may determine a requirement to dry the surface of the first thermal exchanger 210 in dependence on a moisture signal indicating the presence of moisture on the surface. To dry the surface, the vehicle heat pump system 200 may be operated in the heating mode at a second pressure, higher than the usual operating pressure of the vehicle heat pump system 200. During operation of the vehicle heat pump system 200 in the heating mode at the second pressure to dry the surface of the first thermal exchanger 210, a blower (not shown) may optionally be controlled to blow air across the surface of the first thermal exchanger 210. The air flow delivered by the blower may dissipate moisture from a surrounding environment of the first thermal exchanger 210 and thereby accelerate the removal of moisture from the surface of the first thermal exchanger 210 in combination with the heating provided by the operation of the vehicle heat pump system 200 as described above. An operation of the blower may be determined by the a surface temperature requirement of the first thermal exchanger 210. The blower may be controlled by the control system 100, or more specifically by the controller 110. There may also be provided a cooling fan or blower (not shown) arranged to direct air to the surface of the second thermal exchanger 220.

FIG. 3 illustrates a block diagram representation of a vehicle heat pump system 300 according to an embodiment of the invention. The vehicle heat pump system 300 operates similarly to the vehicle heat pump system 200 of FIG. 2, and thus a detailed description of common components is omitted. In particular, the thermal exchangers, the compressor, the expansion device and the accumulator operate in the same manner in FIGS. 2 and 3.

The vehicle heat pump system 300 of FIG. 3 differs from the vehicle heat pump system 200 of FIG. 2 in that an alternative pathway for the fluid to circulate in a heating cycle is provided via conduits 370. Further, the vehicle heat pump system 300 also comprises a check valve 380 and a second expansion device 335. The check valve 380 of FIG. 3 may comprise a one-way valve configured to allow the flow of fluid in one direction and prevent the flow of fluid in the opposite direction. It should be understood that although a second expansion device 335 is shown in FIG. 3, the second expansion device 335 may be omitted or an alternative valve may be provided in the same place, as discussed below.

The vehicle heat pump system 300 may be operated in a cooling mode similar to the vehicle heat pump system 200 of FIG. 2, where fluid passes from the compressor 350, to the control valve 360, the second thermal exchanger 320, the check valve 380, the expansion device 330, the first thermal exchanger 310 and the accumulator 340 before arriving back at the compressor 350. As explained above, the second expansion device 335 may be omitted.

The control valve 360 may control a direction of flow of the fluid to operate the vehicle heat pump system 300 in a heating mode, as indicated by the arrows provided showing a course through the conduits 370 around the vehicle heat pump system 300. In this example, the fluid does not pass through the second thermal exchanger 320, but instead is circulated between the compressor and the first thermal exchanger 310. Thus, hot fluid may be continuously and efficiently provided to the first thermal exchanger 310 to thereby heat a surface of the first thermal exchanger 310 to remove moisture and thereby dry the surface of the first thermal exchanger 310. Fluid may be prevented from entering the second thermal exchanger 320 by the check valve 380 and the control valve 360. The vehicle heat pump system 300 may be operated in the heating mode at a second pressure to dry the surface of the first thermal exchanger 310 as previously explained, for example in dependence on a reception of a moisture signal indicative of moisture on the surface of the first thermal exchanger 310.

The vehicle heat pump system 300 of FIG. 3 also comprises a second expansion device 335. Although an expansion device similar to the first expansion device 330 is shown, it should be understood that any other component such as a valve suitable for restricting the flow of the fluid may be used instead of the second expansion device 335. The second expansion device 335 is configured to restrict a flow of the fluid leaving the first thermal exchanger 310, to thereby contain hot fluid inside the first thermal exchanger 310. Advantageously, an energy consumption of the vehicle heat pump system 300 being operated in the heating mode at the second pressure to dry the surface of the first thermal exchanger 310 may be improved by the provision of the second expansion device 335, as hot fluid may be contained in the first thermal exchanger 310. Consequently, there is a reduced need for fluid to be continuously pumped around the vehicle heat pump system 300, while the temperature of the first thermal exchanger 310 may be maintained at a high temperature. As previously discussed, in some examples, the surface of the first thermal exchanger 310 is heated to at least 50 °C when the pressure of the fluid in the vehicle heat pump system 300 is approximately 14 bar, and to at least 60 °C when the pressure is approximately 20 bar. In some examples, the surface of the first thermal exchanger 310 is heated to approximately 69 °C when the pressure is approximately 20 bar.

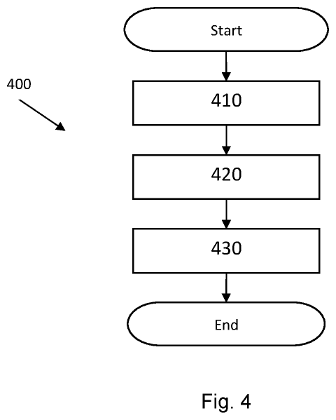

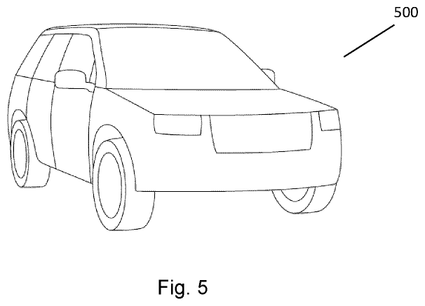

FIG. 4 illustrates a method 400 according to an embodiment of the invention. The method 400 is a method of a control module 100 or a vehicle heat pump system 200, 300 of a vehicle 500, such as the vehicle 500 illustrated in FIG. 5. In particular, the method 400 is a method of removing moisture from a surface of a first thermal exchanger of a vehicle heat pump system operable in a heating mode at a first pressure. The method 400 may be performed by the control system 100 illustrated in FIG. 1, or by the vehicle heat pump system 200, 300 of FIG. 2 or 3. In particular, the memory means 130 may comprise computer-readable instructions which, when executed by the controller 110, perform the method 400 according to an embodiment of the invention. It should be understood that the method 400 may be performed by the vehicle heat pump systems 200, 300 shown in FIG. 2 or 3, but that the method 400 is not limited thereto. The method 400 may be performed by any heat pump system operable in a heating mode.

At block 410, the method comprises receiving a moisture signal indicative of moisture on a surface of the first thermal exchanger. In some examples, the moisture signal is indicative of a use history of the vehicle heat pump system indicating that the vehicle heat pump system has previously operated in a cooling mode. That is, the vehicle heat pump system may operate in a cooling mode to cool a vehicle cabin and provide an air conditioning function to the vehicle cabin. During the cooling mode, the first thermal exchanger is cooled by cold fluid passing through the first thermal exchanger. Due to the first thermal exchanger being cooler than surrounding air, moisture may accumulate on the surface of the first thermal exchanger. In some examples, the moisture signal may indicate that the vehicle heat pump system has been operated in the cooling mode for a predetermined time. The use history may also comprise a number of times the vehicle heat pump has been operated in a cooling mode. In some examples, the moisture signal may also indicate that the vehicle heat pump system is no longer being operated, or that a vehicle journey has finished.

In another example, the moisture signal may be received in dependence on a user's request to dry the surface of the first thermal exchanger. The moisture signal may comprise the user's request to dry the surface of the first thermal exchanger. In some examples, the moisture signal may be any of the above described indication signals, and in response to receiving that indication signal the control system may output an indication to the user recommending that moisture is removed from the vehicle heat pump system. The user may confirm that the drying process should be initiated. In some examples, the recommendation may be provided to the user based on a time since a previous execution of the drying process exceeding a predetermined threshold, or based on a use of the vehicle heat pump system in the cooling mode. The user may also decide to initiate the drying process without a recommendation to do so being output. In some examples, the moisture signal may be received based on a predefined maintenance schedule.

Alternatively or in addition, the moisture signal may be received in dependence on temperature or humidity information received from at least one sensor. For example, the at least one sensor may be provided proximal to the first thermal exchanger and may measure at least one of a temperature or a humidity proximal to the first thermal exchanger. If the measured temperature or humidity exceed a predetermined threshold, a moisture signal may be received.

The moisture signal may be received from a vehicle control system, a vehicle user interface, or from at least one sensor. Alternatively, a controller of a control module of the vehicle heat pump system may determine the moisture signal itself.

At block 420, the method comprises determining a requirement to remove moisture in dependence on the moisture signal. The method may comprise identifying the moisture signal, and determining based on the moisture signal that moisture is likely to be present on the surface of the first thermal exchanger. The method may comprise receiving a moisture signal including information relating to vehicle use history, temperature or humidity information, or information corresponding to user inputs at block 410 as discussed above, and determining a requirement to dry the surface of the first thermal exchanger in dependence on the received information. For example, the method may comprise determining that moisture is likely to be present on the surface of the first thermal exchanger based on the moisture signal. For example, the method may comprise comparing a detected temperature or humidity to a threshold.

At block 430, the method comprises outputting a control signal to control the vehicle heat pump system to operate in the heating mode at a second pressure greater than the first pressure such that the surface of the first thermal exchanger is heated to remove moisture from the surface. The method may comprise controlling a compressor and/or a control valve of the vehicle heat pump system to compress fluid to the second pressure and to control the flow direction of fluid around the vehicle heat pump system to operate the vehicle heat pump system in the heating mode and pass hot fluid through the first thermal exchanger.

The method may comprise operating the vehicle heat pump system in the heating mode at the second pressure for a predetermined time. Alternatively or in addition, the vehicle heat pump system may be operated in the heating mode at the second pressure until temperature or humidity measurements proximal to the first thermal exchanger reach predetermined values.

The method may comprise operating a fan of the vehicle heat pump system to blow air across the surface of the first thermal exchanger to dissipate moisture from air surrounding the first thermal exchanger.

The method may comprise determining to operate the vehicle heat pump system in the heating mode at the second pressure when it is determined that a vehicle has completed a journey, so as not to interfere with a user's desired heating or cooling functions.

In some examples, the second pressure is between 14 bar and 20 bar, and the first pressure is up to 14 bar. In some examples, the surface of the first thermal exchanger is heated to at least 50 °C, to at least 60 °C, or to at least 69 °C. At 50 °C, the surface of the first thermal exchanger is effectively dried. At 60 °C or 69 °C in some examples, bacteria or pathogens present on or around the surface of the first thermal exchanger may be destroyed or deactivated.

After the vehicle heat pump system is operated in the heating mode at the second pressure for the predetermined time or until the temperature or humidity values reach the predetermined threshold values, the method ends. It should be understood that the method 400 of FIG. 4 may occur after a user has exited the vehicle.

FIG. 5 shows a vehicle 500 in accordance with an embodiment of the invention. The vehicle 500 of FIG. 5 may comprise the control system 100 of FIG. 1, the vehicle heat pump system 200 of FIG. 2, or the vehicle heat pump system 300 of FIG. 3. The vehicle 500 may perform the method 400 of FIG. 4.

The vehicle 500 may comprise a heat pump system and a vehicle cabin in which one or more users may travel. The vehicle heat pump system may be used to heat or cool the vehicle cabin based on whether the vehicle heat pump system is operated in a heating mode or a cooling mode. The vehicle heat pump system may be operated in the heating mode at a higher pressure than usual operating pressure to dry a surface of a first thermal exchange.

Advantageously, no additional components need to be included in the vehicle or the vehicle heat pump system to implement the present invention to dry the surface of the first thermal exchanger, which may be applied to any existing vehicle heat pump system. Therefore, manufacture, installation and maintenance are simplified. In addition, the usual operation of the vehicle heat pump system is not affected as in some conventional approaches by the presence of additional components. The surface of the first thermal exchanger can be heated to effectively dry the surface and prevent or reduce a growth of bacteria on the surface, which may contribute to unwanted smells in the vehicle cabin. In addition, by operating the vehicle heat pump system at higher pressures, the surface of the first thermal exchanger may be heated to a temperature higher than normal operation and sufficient to destroy or de-active bacteria or pathogens on or proximal to the surface. It may be determined to dry the surface when it is determined that there is likely to be moisture present on the surface based on various factors, and the drying process may be performed after a journey is completed so as to not interfere with desired vehicle cabin temperature control.

It will be appreciated that various changes and modifications can be made to the present invention without departing from the scope of the present application.

1-15. (canceled)

16. A control system for controlling a vehicle heat pump system, the vehicle heat pump system operable in a heating mode at a first pressure, wherein the control system comprises one or more controllers and is configured to:
receive a moisture signal indicative of moisture on a surface of a first thermal exchanger of the vehicle heat pump system;
determine a requirement to remove moisture in dependence on the moisture signal; and
output a control signal to control the vehicle heat pump system to operate at a second pressure greater than the first pressure such that the surface of the first thermal exchanger is heated to remove moisture from the surface.

17. The control system according to claim 16, wherein the moisture signal is indicative of
at least one of:
the temperature or humidity proximal to the first heat exchanger;
a use history of the vehicle heat pump system indicating that the vehicle heat pump system has previously operated in a cooling mode;
a user input for removing moisture from the surface of the first thermal exchanger; and
an identification that a vehicle comprising the vehicle heat pump system has completed a journey.

18. The control system according to claim 16, wherein the control system is configured to, in dependence on determining the requirement to remove moisture, send an output indication to a user requesting a user confirmation, and
in dependence on receiving user confirmation, output the control signal to control the vehicle heat pump system to operate at the second pressure.

19. The control system according to claim 16, wherein the control system is configured to receive a signal indicative that the vehicle has completed a journey, and wherein the control system is configured to defer output of the control signal to control the vehicle heat pump system to operate at the second pressure until receipt of the signal indicative that the vehicle has completed the journey.

20. The control system according to claim 16, wherein the second pressure is between 14 bar and 20 bar.

21. A vehicle heat pump system operable in a heating mode at a first pressure, the vehicle heat pump system comprising:
a first thermal exchanger; and
the control system according to claim 16.

22. The vehicle heat pump system according to claim 21, wherein the control system is configured to output the control signal to control the vehicle heat pump system to operate at the second pressure in the heating mode such that a temperature of the surface of the first thermal exchanger is raised to at least 50 °C, optionally at least 60 °C.

23. The vehicle heat pump system according to claim 21, comprising a control valve configured to control a direction of flow of the fluid around the vehicle heat pump system to thereby operate the vehicle heat pump system in the heating mode or a cooling mode;
wherein the control valve comprises a three-way valve configured to selectively connect a compressor and the first thermal exchanger via a thermal expansion valve, and to selectively connect the compressor and a second thermal exchanger; and
wherein the three-way valve is configured to selectively direct the fluid to bypass the second thermal exchanger such that hot fluid is circulated through the compressor, the three-way valve, the thermal expansion valve and the first thermal exchanger.

24. The vehicle heat pump system according to claim 21, comprising a valve operable between being opened or restricted to selectively contain fluid in the first thermal exchanger;
wherein the control system is configured to, in response to receiving the moisture signal, output a control signal to control the valve to be restricted to thereby contain hot fluid in the first thermal exchanger.

25. The vehicle heat pump system according to claim 21, comprising at least one of a temperature sensor configured to detect a temperature proximal to the first thermal exchanger or a humidity sensor configured to detect humidity proximal to the first thermal exchanger;
wherein the moisture signal includes at least one of the detected temperature or the detected humidity.

26. A vehicle comprising the control system according to claim 16.

27. A vehicle comprising the heat pump system according to claim 21.
